(19) United States
(12) Patent Application Publication
(10) Pub. No.: US 2003/0227645 A1
(43) Pub. Date: Dec. 11, 2003

(54) Receiving apparatus for signals containing printing data and a printing apparatus for printing data received by the receiving apparatus

(76) Inventors: Kenji Hisatomi, Hirakata-shi (JP); Kazuyuki Murata, Kyotanabe-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/453,480

(22) Filed: Jun. 4, 2003

(30) Foreign Application Priority Data
Jun. 6, 2002 (JP) 2002-166298

(51) Int. Cl. G06F 15/00; G06F 3/12

(52) U.S. Cl. 358/1.13; 358/1.15

(57) ABSTRACT

The receiving apparatus for receiving signals containing printing data comprises a printing data receiving unit operable to receive printing data contained in the signals, a communication unit operable to send or receive the printing data to or from the printer, an external memory writing unit operable to send or receive data to or from the detachable memory card and write the printing data in the memory card, an output destination determination unit operable to select either the printer or the memory card as the output destination of the printing data based on the information on the printer for printing the printing data, and a printing data output unit operable to output the printing data to the destination determined in the output destination determination unit.

### BACKGROUND OF THE INVENTION

(1) Field of the Invention

The present invention relates to a receiving apparatus for signals containing printing data and a printing apparatus for printing printing data received by the receiving apparatus, and especially, a receiving apparatus capable of receiving printing data contained in digital television broadcasting signals and a printing apparatus for printing printing data received by the receiving apparatus.

(2) Description of the Related Art

Digital television broadcasting multiplexes various data and sends the data to viewers' receiving apparatuses. For example, a printing method in which printing data are multiplexed with broadcasting signals has been proposed so far. In this method, a user interface display screen for displaying printing data to users and operational instruction contents responding to user inputs to receiving apparatuses are also multiplexed.

However, there exist plural kinds of receiving apparatuses for digital television broadcasting in the market, and there also exist plural kinds of printing methods for printing printing data.

For example, a receiving apparatus with a communication terminal connectable to the printer standardized as IEEE (Institute of Electrical and Electronic Engineers) 1394 sends printing data to the printer via the communication terminal and a communication line connected to the communication terminal. The printer receives and prints the printing data.

On the other hand, a receiving apparatus without a communication terminal connectable to the printer requires a medium for mediating between a receiving apparatus and a printer. Therefore, for example, a conceivable method is to build a memory card slot in a receiving apparatus and write printing data in a memory card. A user sends printing data stored in the memory card to the printer in any form. For example, a printer with a memory card reader prints printing data when a memory card is inserted into the memory card reader.

In this way, when there are plural kinds of apparatuses for receiving printing data, it is usual that a user can select printing data according to the feature of respective one of receiving apparatuses. For example, in the case of a personal computer, a user firstly selects printing data according to the kind of the personal computer, and display screen for download that displays a plurality of download start buttons so as to download the selected printing data from a server computer.

However, in television broadcasting, there is a problem that television broadcasting can neither prepare printing data for respective kinds of receiving apparatuses nor send those data to receiving apparatuses. It is because printing data must be previously sent for receiving apparatuses along with data for displaying a screen in television broadcasting unlike the case where printing data is sent to a personal computer after selected by a user. It is difficult to previously broadcast all the printing data prepared respective kinds of receiving apparatuses because the broadcast band is limited in broadcasting.

### SUMMARY OF THE INVENTION

The present invention is for solving the above-mentioned problem, and its aim is providing a receiving apparatus that can print printing data in any way suitable for respective receiving apparatuses without preparing printing data for respective kinds of receiving apparatuses.

Providing a printing apparatus that can automatically delete the printed data is also its aim.

The receiving apparatus according to one aspect of the present invention is a receiving apparatus for receiving a signal containing printing data, comprises a printing data receiving unit operable to receive the printing data contained in the signal, an output destination determination unit operable to selectively determine whether to output the printing data to the printing apparatus or not based on the information on the printing apparatus for printing the printing data, a printing data output unit operable to output the printing data to the printing apparatus when the output destination determination unit determined to output the printing data to the printing apparatus.

The receiving apparatus determines whether to output the printing data to the printing apparatus or not based on the information on the printing apparatus by these units. Therefore, there is no need to implement printing control programs respective for a receiving apparatus connectable to a printing apparatus and a receiving apparatus unconnectable to the printing apparatus, and thus it is possible to use one printing control program in common.

Preferably, the receiving apparatus further comprises an external memory writing unit operable to send or receive data to or from a detachable external memory device and write the printing data in the external memory device, wherein the output destination determination unit selects the printing apparatus or the external memory device as an output destination of the printing data based on the information on the printing apparatus, and the printing data output unit outputs the printing data to the destination determined by the output destination determination unit.

The receiving apparatus determines the output destination of the printing data based on the information on the printing apparatus by these units. Therefore, both the receiving apparatus connectable to the printing apparatus and the receiving apparatus unconnectable to the printing apparatus can determine the most suitable output destination of printing data. Therefore, there is no need to prepare printing data for respective receiving apparatuses, and it is possible to print printing data in a way suitable for respective receiving apparatuses. As a user does not have to specify an output destination of printing data, some of the user's load is taken off. In addition, there is no need to implement printing control programs respective for the receiving apparatus connectable to the printing apparatus and the receiving apparatus unconnectable to the printing apparatus, and thus it is possible to implement one printing control program in common.

More preferably, the output destination determination unit selects the printing apparatus as an output destination of the printing data when a control program for printing the printing data using the printing apparatus exists in the receiving apparatus.

The output destination determination unit can determine an output destination of printing data by checking only presence or absence of a control program by these units, and thus only a simple processing is required for determining an output destination of printing data.

More preferably, the receiving apparatus further comprises an output destination specification unit operable to receive specification of an output destination of the printing data from a user, wherein, when a user specifies the output destination of the printing data, the output destination determination unit selects an output destination specified by a user as an output destination of the printing data.

By these units, for example, it is possible to change the output destination to an external memory device even when the printing apparatus is selected as the output destination of the printing data.

More preferably, the receiving apparatus further comprises a program reception unit operable to receive a program in which an output method of the printing data contained in the signals is written, wherein the output destination determination unit determines an output destination of the printing data according to the program.

By these units, operations of the output destination determination unit are written in a program contained in signals. Therefore, for example, if a broadcaster that broadcasts printing data makes a program that disables writing the printing data in an external memory device, which leads to copyright protection.

More preferably, a flag showing “printed” indicates that the printing apparatus finished printing is attached to the printing data stored in the external memory device, and the external memory writing unit deletes the printing data to which the flag showing “printed” is attached out of the printing data stored in the external memory device.

By these units, the receiving apparatus can delete the printing data printed by the printing apparatus.

The receiving apparatus according to another aspect of the present invention is a receiving apparatus for receiving signals containing printing data, comprises a printing data receiving unit operable to receive printing data contained in the signals, an external memory writing unit operable to send or receive data to or from the detachable external memory device and write the printing data in the external memory device, an output destination determination unit operable to select the printing apparatus or the external memory device as the output destination of the printing data based on the information on the external memory device, and a printing data output unit operable to output the printing data to the output destination determined by the output destination determination unit.

The receiving apparatus determines the output destination of the printing data based on the information on the external memory device by these units. Therefore, in the case of a receiving apparatus connected to both an external memory device and a printing apparatus, it is possible to give a higher priority to the external memory device as the output destination of printing data.

The printing apparatus according to still another aspect of the present invention is a printing apparatus for printing printing data stored in a detachable external memory device, the external memory device has a write-protect indication unit operable to show whether data writing is permitted or not, and the printing apparatus comprises a printing data reading unit operable to read the printing data stored in the external memory device, a printing unit operable to print the read printing data, an identifier information memory in which the identifier information of the printing data is stored, a printing data deletion unit operable to delete the printed printing data and the printing data identified by the identifier information stored in the identifier information memory from the external memory device, and a storage unit operable to store the identifier information of the undeleted printing data in the identifier information memory when the printed printing data cannot be deleted from the external memory device.

By these units, when it is impossible to write data in the external memory device, the identifier information of the printing data is temporarily stored in the identifier information memory of the printing apparatus. Therefore, it is possible to delete the undeleted printing data when the external memory device is attached to the printing apparatus once again.

Preferably, the printing apparatus further comprises a warning generation unit operable to generate a warning when the write-protect indication unit of the external memory device does not permit writing.

By these units, a user can know that printing data were not deleted based on a warning. Therefore, a user can operate the write-protect indication unit of the external memory device, make the external memory device data-writable, attach the external memory device to the printing apparatus, and delete the undeleted printing data. Thus a user can surely delete the printing data.

The printing apparatus according to still another aspect of the present invention is a printing apparatus for printing data stored in the detachable external memory device, wherein in the external memory device, printing data and an identifier indicating whether the printing data is printed or not are stored, and the printing apparatus comprises a printing data reading unit operable to read the printing data and the identifier stored in the external memory device, a printing unit operable to print the unprinted printing data with reference to the identifiers, and an identifier value change unit operable to change the identifier value of the printed printing data to a value showing that said printing data is printed.

As to the printing data printed in the printing apparatus, the identifier value of the printing data is changed to the value showing printing completion by these units. Therefore the receiving apparatus can delete the printing data printed in the printing apparatus.

The printing apparatus according to still another aspect of the present invention is a printing apparatus for printing data stored in a detachable external write-once memory device, wherein in the external memory device, printing data and an identifier showing that the printing data is printed are stored, and the printing apparatus comprises a printing data reading unit operable to read the printing data and the identifier stored in the external memory device, a printing unit operable to print the printing data without the associated identifier, and an identifier writing unit operable to write the identifier associated with the printed data in the external memory device.

As to the printed printing data when the external write-once memory device is used, the identifier is written in, the external memory deice by these units. Therefore, it is possible to limit printing times of the printing data and thus protect the copyright.

Note that the present invention can be realized as a printing system for television broadcasting in which the above-mentioned receiving apparatus and the printing apparatus are utilized in combination. Also, the processing executed in the above-mentioned receiving apparatus and the printing apparatus can be realized as a method.

### FURTHER INFORMATION ABOUT TECHNICAL BACKGROUND TO THIS APPLICATION

filed , is incorporated herein by reference.

Japanese Patent application No. 2002-166298 filed Jun. 6, 2002.

### BRIEF DESCRIPTION OF THE DRAWINGS

These and other subjects, advantages and features of the invention will become apparent from the following description thereof taken in conjunction with the accompanying drawings that illustrate a specific embodiment of the invention. In the Drawings:

FIG. 1 is a block diagram showing the hardware structure of a first receiving apparatus of a first embodiment in the present invention.

FIG. 2 is a block diagram showing the hardware structure of a second receiving apparatus of the first embodiment in the present invention.

FIG. 3 is a diagram showing the hardware structure of a printer operable to print printing only data written in a memory card.

FIG. 4 is a diagram showing the hardware structure of a printer can be used when connected to the receiving apparatus shown in FIG. 1.

FIG. 5 is a diagram showing an example of decoded data contained in decoded data signals.

FIG. 6 is a diagram showing an example of display script files shown in FIG. 5.

FIG. 7 is a flow chart showing the processing executed by the receiving apparatus.

FIG. 8 is a diagram showing the appearance of an example monitor whose display screen shows a printing button.

FIG. 9 is a diagram showing an example of directories made in a memory card.

FIG. 10 is an illustration showing flags associated with respective printing only data stored in the memory card.

FIG. 11 is a flow chart showing the processing executed by the printer shown in FIG. 3.

FIG. 12 is a flow chart showing the processing executed by the printer shown in FIG. 4.

FIG. 13 is a flow chart showing the processing executed by the receiving apparatus.

FIG. 14 is a flow chart showing the processing executed by the printer shown in FIG. 3.

FIG. 15 is a flow chart showing the processing executed by the receiving apparatus.

FIG. 16 is a flow chart showing the processing executed by the printer shown in FIG. 3.

FIG. 17 is a diagram showing the appearance of the printer with a display unit.

FIG. 18 is a diagram showing the appearance of an example monitor whose display screen shows output destination specification buttons.

FIG. 19 is a diagram showing the appearance of an example personal computer when an authoring tool that displays a copyright protection button is being executed on the display screen.

FIG. 20 is an illustration summarizing operations of the printing system for television broadcasting concerning the embodiments in the present invention.

### DESCRIPTION OF THE PREFERRED EMBODIMENT(S)

[First Embodiment]

A printing system for television broadcasting concerning the first embodiment in the present invention will be explained below with reference to figures. This first embodiment is the case on assumption that printing only data are multiplexed to digital television broadcasting and send. The components that have the same action and the same functionality are given the same name and the same reference mark in the following explanation, and the explanation is omitted as appropriate.

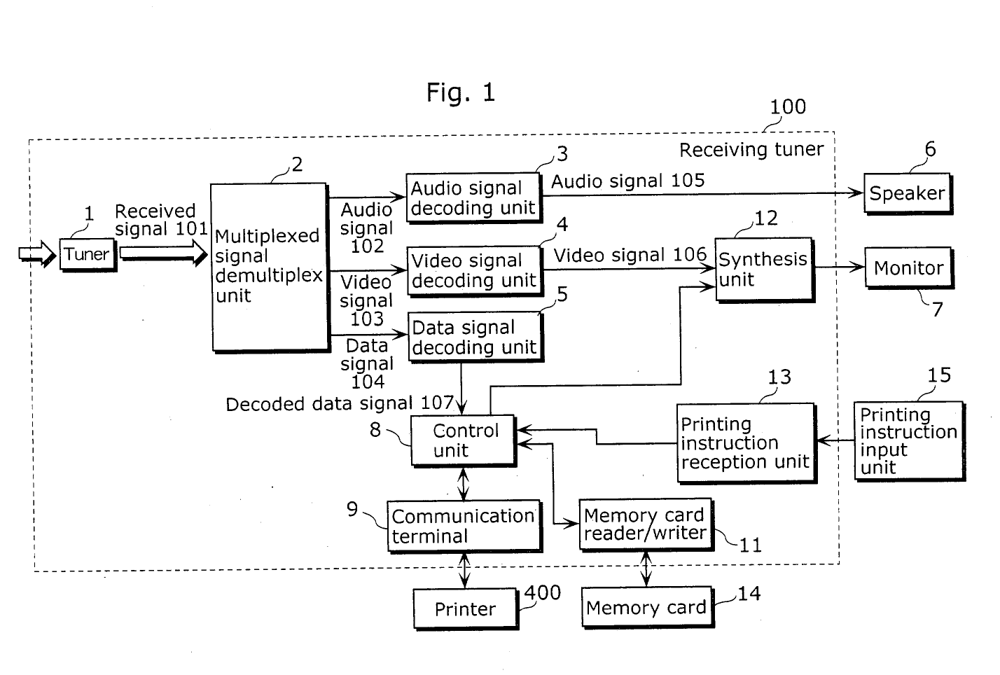

FIG. 1 is a block diagram showing the hardware structure of the first receiving apparatus 100 of the first embodiment in the present invention. Receiving apparatus 100 is an apparatus for receiving television broadcasting signals and outputting video, audio and printing only data (which is used only for printing) contained in the television broadcasting signals, and the receiving apparatus comprises tuner 1, multiplexed signal demultiplex unit 2, audio signal decoding unit 3, video signal decoding unit 4, data signal decoding unit 5, control unit 8, communication terminal 9, memory card reader/writer 11, synthesis unit 12, and printing instruction reception unit 13.

Tuner 1 receives digital television broadcasting signals for the channel desired by a user via an antenna (not shown in any figure), and outputs received signal 101.

Multiplexed signal demultiplex unit 2 demultiplexes received sinal 101 into audio signal 102, video signal 103 and later-described data signal 104.

Audio signal decoding unit 3 decodes coded audio signal 102 and outputs audio signal 105. Audio signal 105 is outputted from speaker 6.

Video signal decoding unit 4 decodes coded video signal 103 and outputs video signal 106.

Synthesis unit 12 synthesizes video signal 106 into a user interface display screen outputted from control unit 8 and outputs the synthesized video signals to monitor 7. Monitor 7 displays the synthesized video signals.

Data signal decoding unit 5 decodes coded data signal 104 and outputs decoded data signal 107. Decoded data signal 107 contains printing only data to be a printing target, and further explanation for decoded data signal 107 will be made later on.

Printing instruction reception unit 13 receives a printing instruction for printing only data inputted by a user through printing instruction input unit 15.

Communication terminal 9 plays a role in connecting printer 400 to receiving apparatus 100. Communication terminal 9 satisfies the IEEE1394 standard. Communication terminal 9 is not limited to IEEE1394, in other words, any standard capable of communicating with the printer will do.

Memory card reader/writer 11 can detach memory card 14, write data in memory card 14, and read data from memory card 14.

Control unit 8 includes an unshown CPU (Central Processing Unit), a memory and a hard disc. Control unit 8 displays a user interface display screen on monitor 7 via synthesis unit 12 based on the contents of decoded data signal 107 and the printing instruction outputted by printing instruction reception unit 13, prints printing only data using printer 400, and writes printing only data in memory card 14.

In other words, various functions are prepared in control unit 8, and these functions are called and executed based on the contents of decoded data signal 107 and the above-mentioned printing instruction. Functions used here means subroutine programs for control written in a machine language, and for convenience of explanation, the programs are written in a function type high-level language such as C language. More specifically, prepared functions are as follows: functionality detection function isFunctiono, printing execution function goPrint(), writing function writeMemorycard(), printing button function displayButton(), user input function clickButton(), and so on.

Functionality detection function isFunction() is a function whose return value is whether the function specified as the argument is prepared in control 8 or not. Print execution function goPrint() is a function for outputting print only data from a receiving apparatus via communication terminal 9 and executing printing.

Writing function writeMemorycard() is a function for writing printing only data in memory card 14. Printing button function displayButton() is a function for displaying a printing button on the monitor. User input function clickButton() is a function for notifying control unit 8 that printing instruction input unit 15 issued a printing instruction.

Receiving apparatus 100 outputs printing only data to memory card 14 or printer 400.

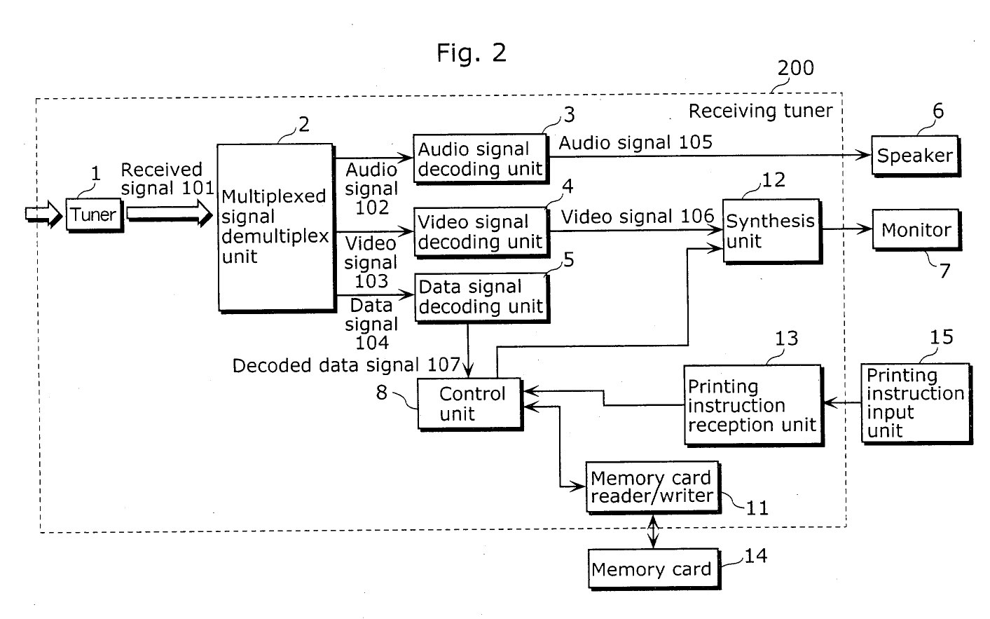

FIG. 2 is a block diagram showing the hardware structure of the second receiving apparatus 200 of the first embodiment in the present invention. Receiving apparatus 200 is an apparatus for receiving television broadcasting signals and outputting video, audio and printing only data contained in the television broadcasting signals, and has the structure of receiving apparatus 100 without communication terminal 9. As receiving apparatus 200 does not have communication terminal 9, printing execution function goPrint() is not prepared in control unit 8. The other components are the same as receiving apparatus 100. Therefore, detailed explanation for those components is not repeated here. Receiving apparatus 200 outputs printing only data to memory card 14.

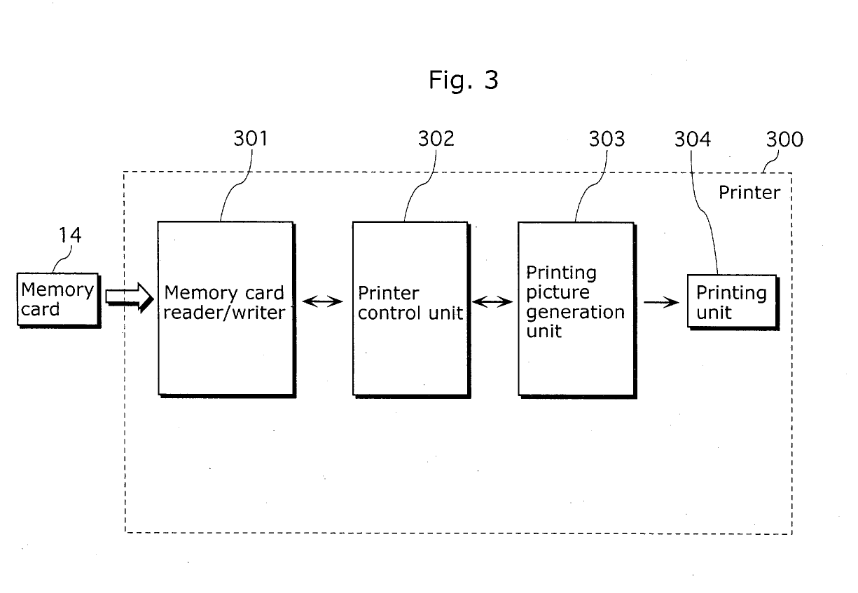

FIG. 3 is a diagram showing the hardware structure of printer 300 for printing printing only data written in memory card 14. Printer 300 is a printing apparatus for printing printing only data written in memory card 14, and comprises memory card reader/writer 301, printer control unit 302, printing picture generation unit 303, and printing unit 304.

Memory card reader/writer 301 reads printing only data stored in memory card 14. Memory card 14 is inserted into memory card reader/writer 301 by a user.

Printer control unit 302 controls the timing of reading printing only data stored in memory card 14, executes suitable processing to the printing only data read by memory reader/writer 301 and sends the data to printing picture generation unit 303.

Printing picture generation unit 303 transforms the printing only data received by printer control unit 302 into bit map data, and sends the data to printing unit 304. Printing unit 304 composed of an ink head and so on, and prints the bit map data on printing paper and the like. Printer 300 prints printing only data stored in memory card 14.

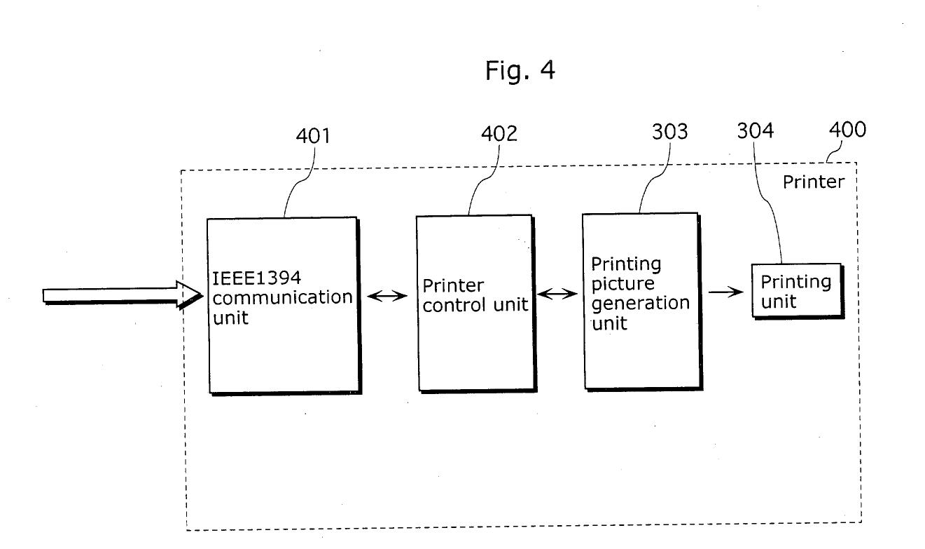

FIG. 4 is a diagram showing the hardware structure of printer 400 used when connected to receiving apparatus 100 shown in FIG. 1. Printer 400 is a printing apparatus for printing printing only data received from receiving apparatus 100, and comprises IEEE1394 communication unit 401, printer control unit 402, printing picture generation unit 303, and printing unit 304.

IEEE1394 communication unit 401 receives printing only data via communication terminal 9 of receiving apparatus 100. Printer control unit 402 executes suitable processing to the printing only data received by IEEE1394 communication unit 401, and sends the data to printing picture generation unit 303. As the following processing is the same as the processing executed by printer 300, the same numbers as used in FIG. 3 are assigned and explanations will be omitted. Printer 400 prints printing only data received by IEEE1394 communication unit 401.

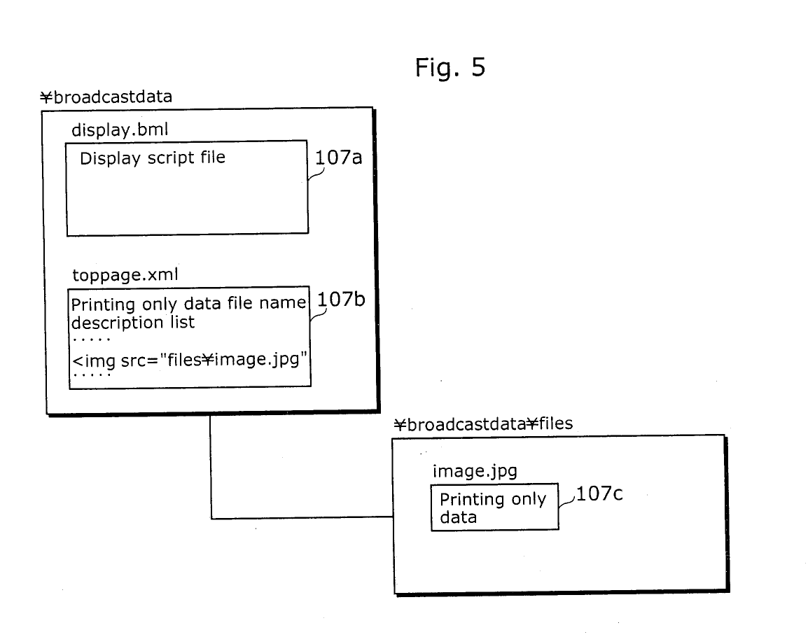

FIG. 5 is a diagram showing an example of decoded data contained in decoded data signal 107. Decoded data include display script file 107a, printing only data file name description list 107b, and printing only data 107c.

Contents to be displayed on monitor 7 and the program to be executed in control unit 8 are written in BML (Broadcast Markup Language) in display script file 107a. The file name list of printing only data 107c is written in XHTML (extensible Hypertext Markup Language), that is, a print language (to which printing-related description method is added in XHTML) in printing only data file name description list 107b. It is possible to contain a link destination to printing only data 107c solely or the link destination along with the file name of printing data 107c in printing only data file name description list 107b. Printing only data 107c is the entity data to be printed. Printing only data file name description list 107b and printing only data 107c are considered as different from each other in this description, but both of these data can be considered as one printing only data.

Display script file 107a and printing only data file name description list 107b are stored as file names of “display. bml” and “toppage. xml” respectively in the directory of “ [symbol] broadcastdata” in the hard disc inside control unit 8.

Printing only data 107c, that is still picture data of JPEG (Joint Photographic Experts Group) format, is stored as a file name of “image. jpg” in the directory of “ [symbol] broadcastdata [symbol] files” in the hard disc.

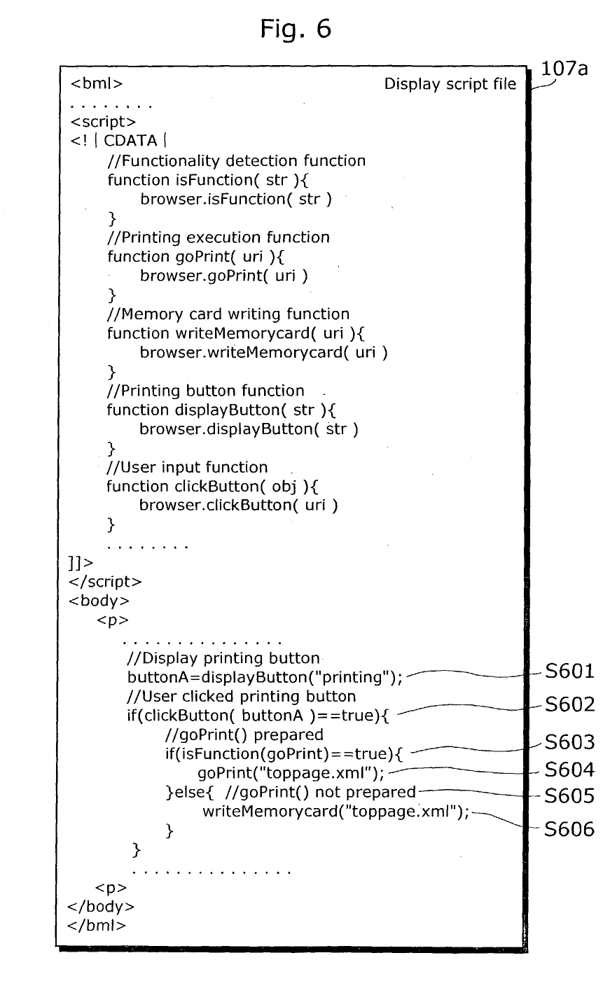

FIG. 6 is a diagram showing an example of display script file 107a shown in FIG. 5. Respective functions to be used in control unit 8 are defined in the first half of display script file 107a (the part from <script> to </script>), and programs to be executed in control unit 8 are written in the second half of display script file 107a (the part from <body> to </body>).

Programs to be executed in control unit 8 will be explained. A printing button prepared by the supplier of printing only data is displayed on monitor 7 (S601). Whether a user clicked the printing button displayed on monitor 7 or not is judged (S602). When the user clicked the printing button, whether printing execution function goPrint() is prepared or not is judged (S603). When printing execution function goPrint() is prepared, printing only data written in printing file name description list “toppage. xml” is printed (S604). As mentioned above, when printing only data file name description list 107b and printing only data 107c are considered as one printing only data, the data which is linked to the contents of the text written in printing file name description list “toppage. xml” is printed. When printing execution function goPrint() is not prepared (S605), printing file name description list “toppage. xml” and printing only data written in the printing file name description list “toppage. xml” are written in memory card 14 (S606).

Next, operations of the printing system for television broadcasting composed as mentioned earlier will be explained.

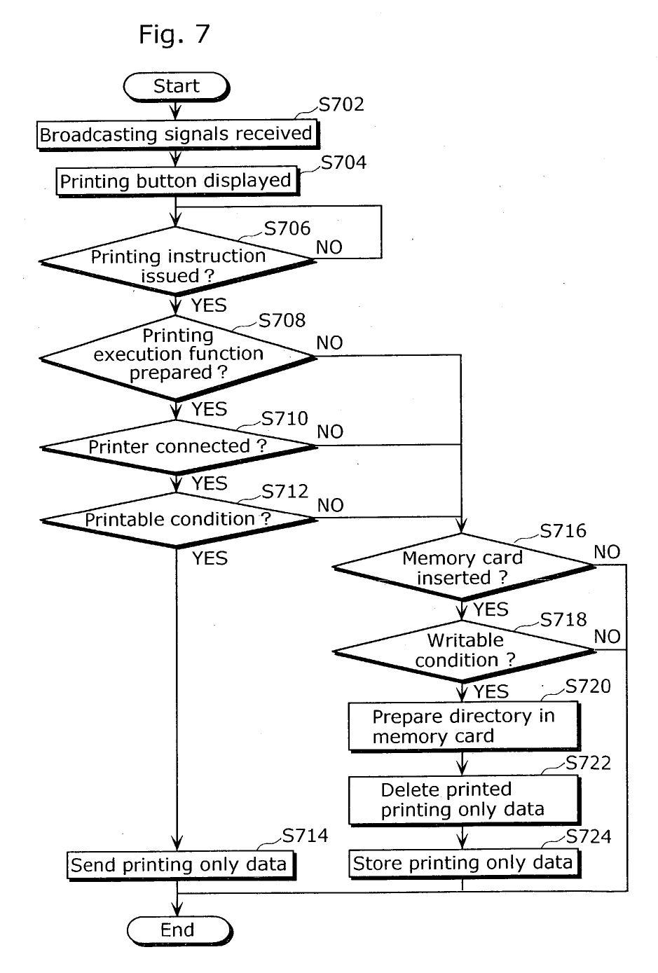

FIG. 7 is a flow chart showing the processing executed by receiving apparatus 100 (200). First, the processing executed by receiving apparatus 100 shown in FIG. 1 will be explained, and then the processing executed by receiving apparatus 200 will be explained.

Tuner 1 of receiving apparatus 100 receives digital television signals of the channel desired by a user (S702). Control unit 8 executes the following processing according to display script file 107a contained in decoded data signal 107. Note that the following processing is finer than the processing of the program written in display script file 107a shown in FIG. 6.

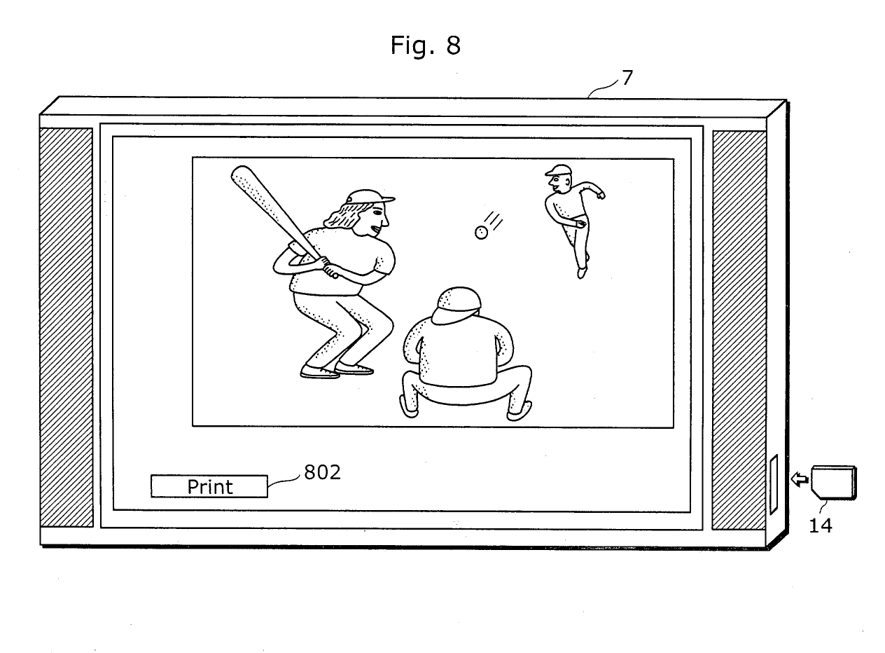

As shown in FIG. 8, control unit 8 displays printing button 802 for having printing only data 107c printed on monitor 7 (S704). Control unit 8 judges whether an instruction for printing printing only data 107c was issued or not by detecting the resulting input information from a user's operation via a remote control and the like, that is, by judging whether printing button 802 is selected or clicked (S706). When there is no printing instruction (S706: NO), control unit 8 waits for a printing instruction (S706). When there is a printing instruction (S706: YES), control unit 8 judges whether printing execution function goPrint() is prepared or not (S708).

As printing execution function goPrint() is already prepared in control unit 8 of receiving apparatus 100 (S708: YES), control unit 8 judges whether printer 400 is connected to communication terminal 9 (S710). When printer 400 is connected (S710: YES), control unit 8 judges whether printer 400 is ready for printing or not by obtaining the information on the printer condition from printer 400 (S712). Being ready for printing here means that printer 400 is power-supplied, and printing paper and ink or toner are ready. In the case where there is no module called a spooler that stores printing instructions either in receiving apparatus 100 or printer 400, the condition for printing is not ready even when printer 400 is executing the previous printing instruction. When printer 400 is ready for printing (S712: YES), receiving apparatus 100 sends printing only data 107c to printer 400 (S714) and thus printer 400 prints printing only data 107c by sending printing only data 107c to printer 400.

When printer 400 is not connected to communication terminal 9 (S710: NO) or when printer 400 is connected to communication terminal 9 but printer 400 is not ready for printing (S710: YES, 5712: NO), control unit 8 tries to write printing only data 107c in memory card 14. It is also possible to ask a user whether it is possible to write in a memory card because the printer cannot be used before trying to write in memory card 14.

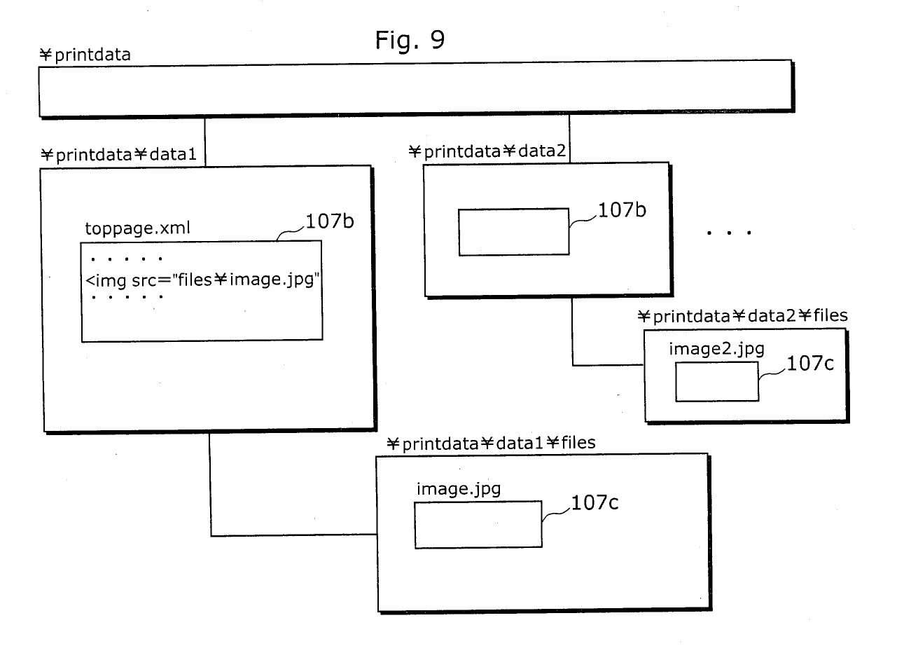

Control unit 8 judges whether memory card 14 is inserted into memory card reader/writer 11 or not (S716). When memory card 14 is inserted (S716: YES), control unit 8 judges whether memory card 14 is ready for writing or not (S718). When memory card 14 is ready for writing (S718: YES), control unit 8 prepares a directory 1 which will be the storage destination of printing only data file name description list 107b and a directory which will be the storage destination of printing only data 107c in memory card 14 shown in FIG. 9 in order to store printing only data 107c in memory card 14 (S720). Note that control unit 8 checks whether there is a directory of “ [symbol] printdata” in memory card 14. When there is no directory of “ [symbol] printdata”, control unit 8 makes a directory of “ [symbol] printdata”, a directory of “printdataYdatal” to be a storage destination of printing only data file name description list 107b, and a directory of “ [symbol] printdata [symbol] data1 [symbol] files” to be a storage destination of printing only data 107c. When there is a directory of “ [symbol] printdata” in memory card 14, control unit 8 makes directories as storage destinations for printing only data file name description list 107b and printing only data 107c under the directory “ [symbol] printdata” using a name different from those of existing directories. For, example, as shown in FIG. 9, control unit 8 makes a directory of “ [symbol] printdataYdata2” as a storage destination of printing only data file name description list 107b and a directory of “ [symbol] printdata [symbol] data2 [symbol] files” as a storage destination of printing only data 107c.

Data to be stored in memory card 14 is not limited to printing data, for example, it is also possible to transform the information on a printing job such as “print XX pages” into a file and store the file in memory card 14.

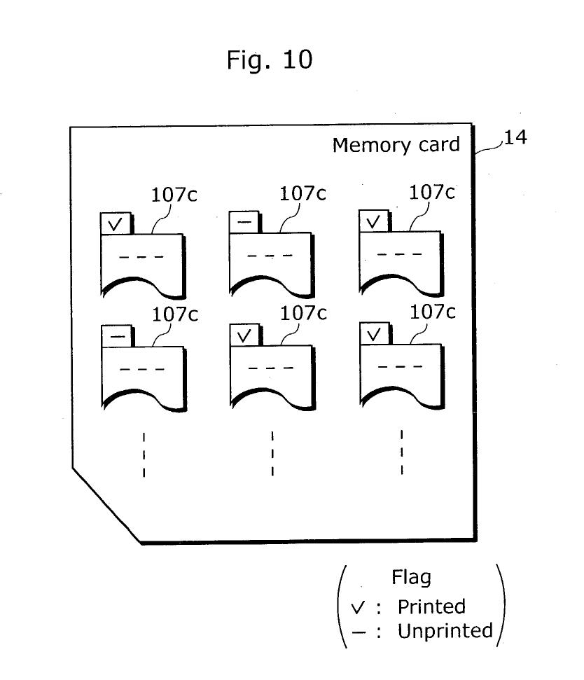

Control unit 8 deletes the data that have already printed by printer 300 of printing only data 107c stored in memory card 14 (S722). As will be mentioned later, printer 300 prints printing only data 107c and then stores flags showing “printed” associated with the printing only data 107c in memory card 14. For example, as shown in FIG. 10, respective printing only data 107c stored in memory card 14 are given a flag. There are two kinds of flags, that is a flag showing “printed”0 as mentioned above and a flag showing “unprinted”. The printing only data 107c associated with flags showing “printed” are deleted in the deletion processing (S722).

Control unit 8 stores (S724) printing only data file name description list 107b and printing only data 107c in the storage destinations (such as a directory of “ [symbol] printdata [symbol] data1” and “ [symbol] printdata [symbol] data1 [symbol] files”) in memory card 14 made in the directory making processing (S720).

When memory card 14 is not inserted into memory card reader/writer 11 (S716: NO), or when it is impossible to write data in memory card 14 because the write protect switch of the memory card 14 is on or for any reason (S718: NO), control unit 8 notifies a user of the situation and finishes processing.

Next, the processing executed by receiving apparatus 200 will be explained. Receiving apparatus 200 executes processing from broadcasting signal reception processing (S702) to function presence/absence judgment processing (S708) as receiving apparatus 100 does.

As printing execution function goPrint() is not prepared previously in control unit 8 of receiving apparatus 200 as mentioned above (S708: NO), receiving apparatus 200 executes processing from memory card insertion judgment processing (S716) to printing only data storage processing (S1324) as receiving apparatus 100 does.

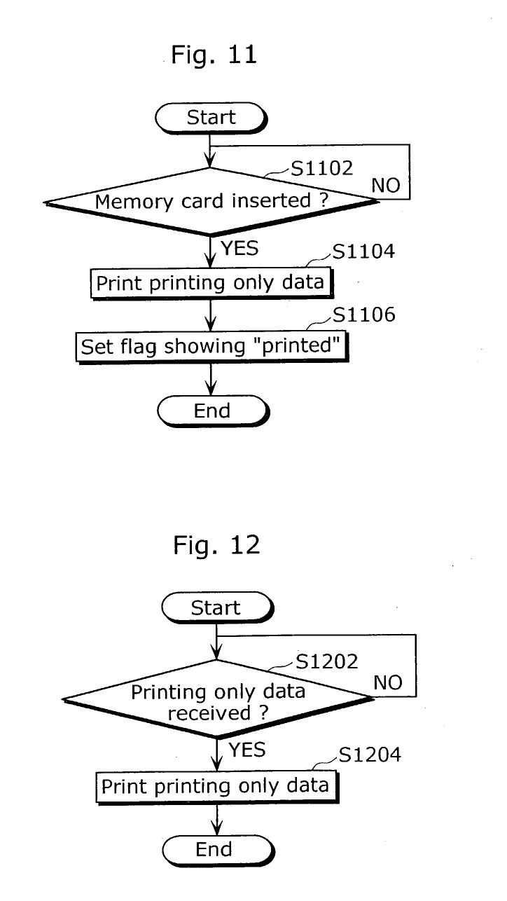

FIG. 11 is a flow chart showing the processing executed by printer 300 shown in FIG. 3. Printer control unit 302 judges whether memory card 14 is inserted into memory card reader/writer 301 or not (S1102). When memory card 14 is not inserted (S1102: NO), printer control unit 302 waits until memory card 14 is inserted.

When memory card 14 is inserted (S1102: YES), printer control unit 302 has printing unit 304 print the unprinted printing only data 107c stored under the directory “ [symbol] printdata” of memory card 14 via printing picture generation unit 303 (S1104). In other words, printer control unit 302 prints printing only data 107c associated with a flag showing “printed”.

At the end of printing, printer control unit 302 writes flags showing “printed” associated with the printed printing only data 107c in memory card 14 (S1106). In this way, printing only data 107c stored in memory card 14 is printed.

FIG. 12 is a flow chart showing the processing executed by printer 400 shown in FIG. 4. Printer control unit 402 judges whether receiving apparatus 100 has already received printing only data 107c or not via IEEE1394 communication unit 401 (S1202). When printer control unit 402 has not received printing only data 107c yet (S1202: NO), the unit waits until it receives the data.

When printer control unit 402 receives printing only data 107c (S1202: YES), the unit has printing unit 304 print printing only data 107c via printing picture generation unit 303 (S1204).

As explained up to this point, a receiving apparatus switches output destinations of printing only data based on the presence or absence of printing execution function goPrint() in the first embodiment. Therefore, it is possible to output printing only data to a suitable output destination even when there concurrently exist a receiving apparatus with a communication terminal connectable to a printer and a receiving apparatus without such a communication terminal.

Also, other than printing only data, display script file in which an output method of the printing only data is written is contained in the digital television broadcasting signals received by the tuner. Therefore, the receiving apparatus can output printing only data to a suitable destination by executing the program written in the display script file, and thus a broadcaster can reduce the data amount of broad casting signals because there is no need to broadcast printing only data for respective kinds of receiving apparatuses.

[Second Embodiment]

A printing system for television broadcasting concerning this second embodiment of the present invention will be explained below.

The printing system for television broadcasting concerning this second embodiment of the present invention has the same hardware structure as the printing system for television broadcasting of the above-mentioned first embodiment.

This second embodiment differs from the first embodiment in that not receiving apparatus 100 (200) but printer 300 deletes the printed printing only data 107c stored in memory card 14.

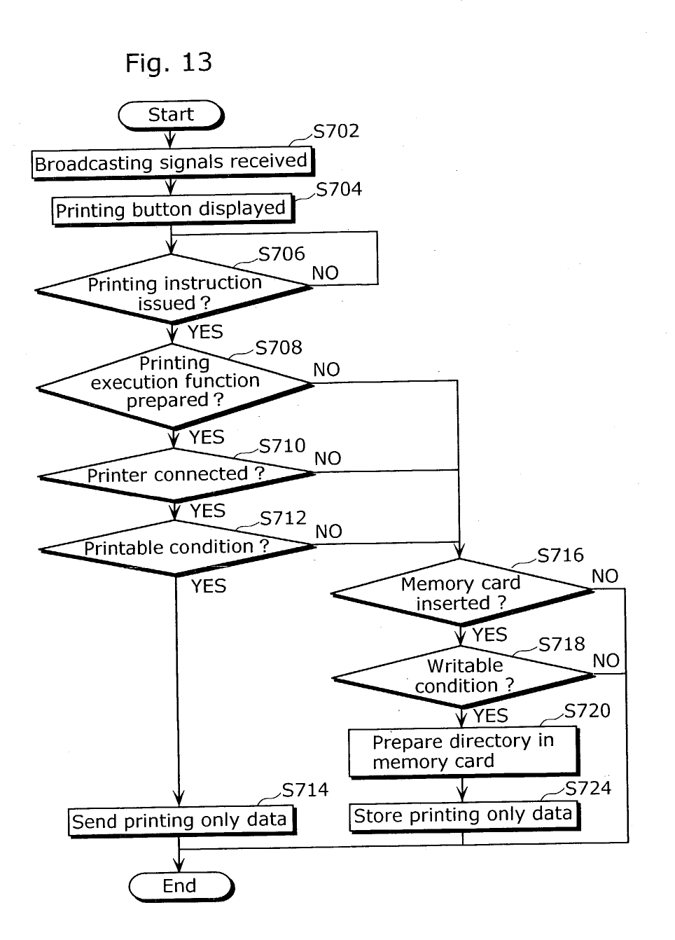

FIG. 13 is a flow chart showing the processing executed by receiving apparatus 100 (200). As mentioned above, receiving apparatus 100 (200) does not delete printing only data 107c. In the flow chart as FIG. 13, printing only data deletion processing (S722) is deleted from the flow chart of the processing executed by the receiving apparatus 100 (200) in the first embodiment shown as FIG. 7. In other words, receiving apparatus 100 (200) in the second embodiment executes the same processing as receiving apparatus 100 (200) in the first embodiment except that receiving apparatus 100 (200) in the second embodiment does not delete the printed printing only data 107c.

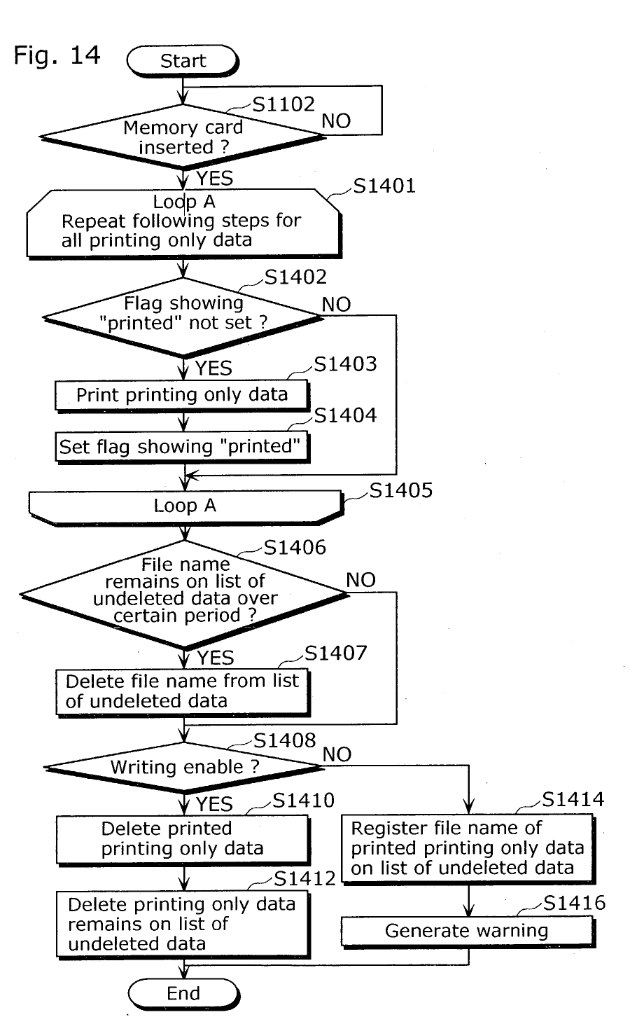

FIG. 14 is a flow chart showing the processing executed by printer 300 shown in FIG. 3. Memory card insertion judgment processing (S1102) is the same as memory card insertion judgment processing (S1102) executed by printer 300 in the first embodiment shown in FIG. 11.

When memory card 14 is inserted into memory card reader/writer 301 (S1102: YES), printer control unit 302 checks whether a flag showing “printed” is set to each printing only data 107c stored under the directory of “ [symbol] printdata” in memory card 14 (S1402). A flag showing “printed” used here is a flag set to the printed printing only data 107c, and the flag is stored in printer control unit 302 in printer 300. As to printing only data to which a flag showing “printed” is not set (S1402: YES), printing only data 107c is printed by printing unit 304 via printing picture generation unit 303 (S1403). After that, a flag showing “printed” associated with the printed printing only data 107c is stored in printer control unit 302 (S1404). As to printing only data to which a flag showing “printed” is set (S1402: NO), printing processing is not executed because it is done. The printing processing mentioned above is executed on all printing only data (S1401˜S1405).

Printer control unit 302 checks whether there is any file name that remains on the list of undeleted data over a certain period or not (S1406). A “list of undeleted data” used here is a list which is made in printer control unit 302, and file names of printing only data 107c which have already printed but have not deleted yet are stored in the list of undeleted data. “A certain period” can be several hours or few days. When there is a file name that remains on the list of undeleted data over a certain period (S1406: YES), printer control unit 302 regards that the user does not have the will to delete printing only data 107c associated with the file name and deletes the file name from the list of undeleted data (S1407).

After the deletion processing of file names from the list of undeleted data (S1407) or when there is no file name that remains on the list of undeleted data over a certain period (S1406: NO), printer control unit 302 judges whether it is possible to write data in memory card 14 or not (S1408). More specifically, printer control unit 302 judges whether the write protect switch of memory card 14 is on or not.

When it is possible to write data in memory card 14 (S1408: YES), printer control unit 302 deletes (S1410) printing only data 107c printed in the printing processing (S1403) and to which a flag showing “printed” is set. At the same time, printer control unit 302 deletes flags showing “printed”. Also, printer control unit 302 deletes printing only data 107c associated with the file name registered on the list of undeleted data and the file name stored in the list of undeleted data simultaneously (S1412).

When the condition is not ready for writing data in memory card 14 (S1408: NO), it is impossible to delete the printed printing only data 107c. Therefore, printer control unit 302 registers (S1414) the file name of the printed printing only data 107c in printing processing (S1402). After that, printer control unit 302 generates a warning using an unshown speaker (S1416) and the like in order to inform the user of the existence of undeleted printing only data 107c. For example, it is possible to have printer control unit 302 make a message such as “Printing only data in the memory card cannot be deleted.” from its speaker or make an audible alarm.

The process executed by printer 400 shown in FIG. 4 is the same as the processing executed by printer 400 explained with reference to FIG. 12 in the first embodiment.

As explained up to this point, the present invention in the second embodiment has the effects of the first embodiment plus the following effect.

In other words, the printer deletes the printed printing only data stored in a memory card in the second embodiment. Therefore, the user do not have to insert a memory card into the receiving apparatus once again in order to delete the data after printing printing only data stored in the memory card, which leads to saving the user's time and trouble.

In the case where the write protect switch of a memory card is on or the like at the time of the printer deleting the printed printing only data, the file names of the printing only data are registered on the list of undeleted data. Thanks to the registration, it becomes possible to delete the undeleted printing only data next time the user inserts the memory card into the printer and prints the printing only data.

In addition, when the write protect switch of a memory card is on, the printer generates a warning. Therefore, the warning prevents the user from failing to delete printing only data.

Note that it is possible to delete a flag showing “printed” in setting order when trying to register a new flag showing “printed” over the memory capacity of printer control unit 302.

[Third Embodiment]

Next, a printing system for television broadcasting of the third embodiment in the present invention will be explained.

The printing system for television broadcasting of the third embodiment in the present invention has the same hardware structure as the printing system for television broadcasting in the above-mentioned first embodiment.

This third embodiment differs from the first embodiment and the second embodiment in that memory card 14 has higher priority than printer 400 as an output destination when receiving apparatus 100 outputs printing only data 107c. Also, memory card 14 in this third embodiment is write-once type. In other words, it is impossible to delete the written data while it is possible to write additional data in the memory card 14 later on.

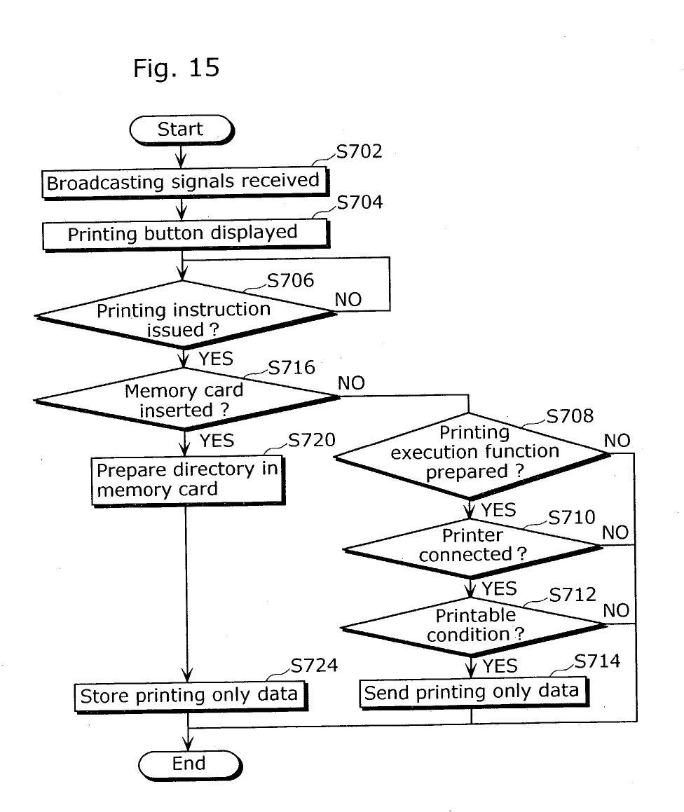

FIG. 15 is a flow chart showing the processing executed by receiving apparatus 100 (200). Its processing from broadcasting signals reception processing (S702) to printing instruction judgment processing (S706) is the same as the processing executed by receiving apparatus 100 (200) shown in FIG. 7 in the first embodiment.

In response to a printing instruction (S706: YES), control unit 8 of receiving apparatus 100 (200) judges whether memory card 14 is inserted into memory card reader/writer 11 or not (S716). When memory card 14 is inserted (S716: YES), control unit 8 executes directory making processing (S720) and printing only data storage processing (S1324). This processing is the same as the processing executed by receiving apparatus 100 (200) shown in FIG. 7 in the first embodiment.

When memory card 14 is not inserted into memory card reader/writer 11 (S716: NO), control unit 8 judges whether printing execution function goPrint() is prepared or not (S708).

As printing execution function goPrint() is previously prepared in control unit 8 of receiving apparatus 100 (S708: YES), processing from printer connection judgment processing (S710) to printing only data sending processing (S714) is executed. This processing is the same as the processing executed by receiving apparatus 100 shown in FIG. 7 in the first embodiment.

As printing execution function goPrint() is not prepared previously in control 8 of receiving apparatus 200 (S708: NO), the processing finishes.

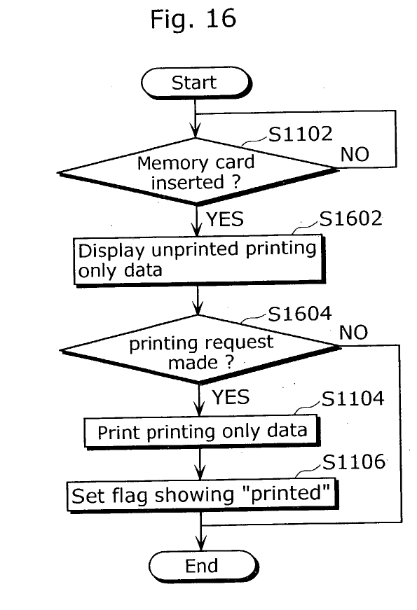

FIG. 16 is a flow chart showing the processing executed by printer 300 shown in FIG. 3. Printer control unit 302 executes memory card insertion judgment processing (S1102). This processing is the same as the memory card insertion judgment processing (S1102) executed by printer 300 shown in FIG. 11 in the first embodiment.

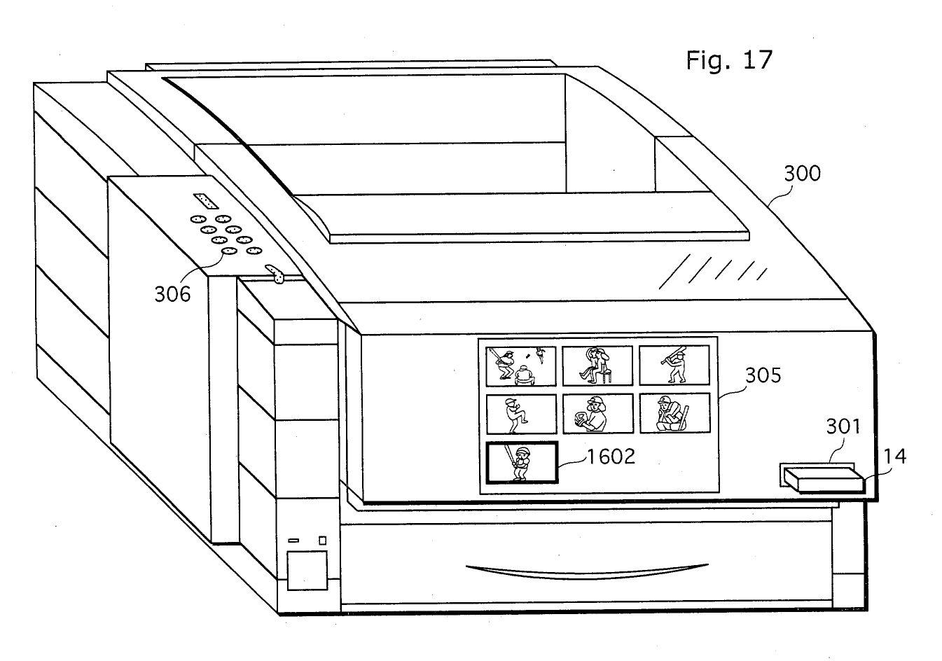

When memory card 14 is inserted into memory card reader/writer 301 (S1102: YES), printer control unit 302 has display unit 305 of printer 300 as shown in FIG. 17 display the unprinted printing only data 107c (S1602). For example, seven unprinted printing only data 107c are displayed on display unit 305. The black-bordered printing only data 1602 is now selected as printing only data 107c, that is, the printing target. Judgment on whether one of printing only data 107c is printed or not is made according to whether a flag showing “printed” associated with the printing only data 107c is written in memory card 14.

Printer control unit 302 judges whether there is a user request for printing printing only data 107c or not (S1604). A request for printing printing only data 107c is made after operating operation button 306 of printer 300 shown in FIG. 17 and selecting printing only data 1602 displayed on display unit 305 as a printing target. Note that only one printing only data 1602 is not always selected to be printed, but two or more printing only data 1602 can be selected.

When there is a printing request for printing only data 107c (S1604: YES), printing processing (S1104) and writing processing of a flag showing “printed” (S1106) is executed. This processing is the same as shown in FIG. 11.

When there is a printing request for printing only data 107c (S1604: NO), printer control unit 302 finishes the processing.

The processing executed by printer 400 as shown in FIG. 4 is the same as the processing executed by printer 400 in the first embodiment explained with reference to FIG. 12.

As explained up to this point, this third embodiment has the following effect in addition to the effect of the first embodiment.

In other words, unlike the above-mentioned embodiments, this third embodiment gives higher priority as an output destination of printing only data to a memory card than a printer. Therefore, a user can store printing only data in a memory card one after another and then print the stored data all together.

Also, as to the printing only data printed from a write-once memory card, a flag showing “printed” is written to the memory card. Therefore, it is possible to limit the printing times of printing only data, and thus it is possible to protect a copyright.

Up to this point, explanation for the printing system for television broadcasting in the present invention is made based on these embodiments, but the present invention is not limited to these embodiments.

For example, a write-once memory card is used in the third embodiment, the other type of memory card can also be used. In the case of using the other type of memory card, it is possible to delete the printing only data with a flag showing “printed” when inserting a memory card with the data into a memory card reader/writer.

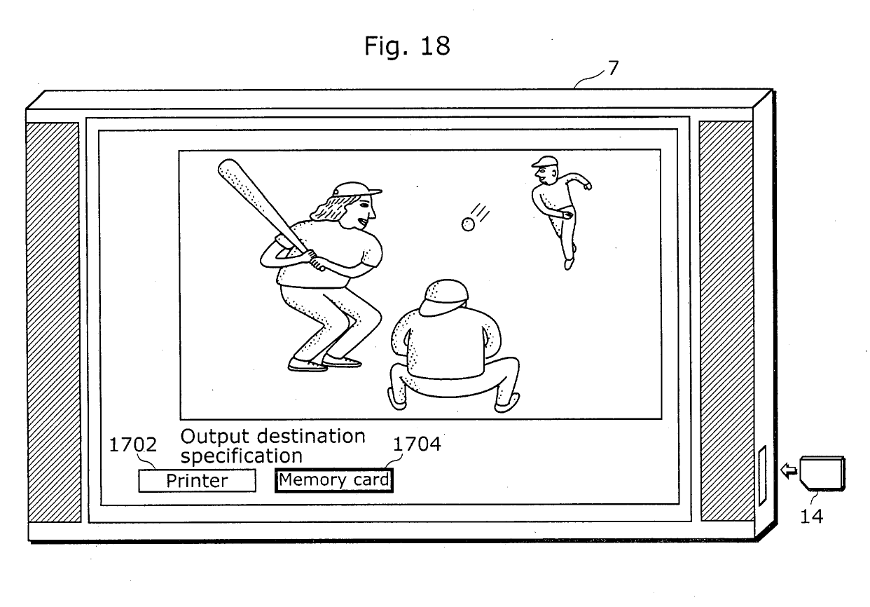

Also, an output destination of printing only data is determined based on presence or absence of printing execution function goPrint() and so on in the above-mentioned embodiments, it is also possible to let a user change the output destination finally. For example, as shown in FIG. 18, when a receiving apparatus outputs printing only data to a printer or a memory card, output destination specification buttons 1702 and 1704 are displayed on monitor 7. When a user wants to change the output destination, the user selects button 1702 or 1704 using a remote control to change the output destination. In the case of FIG. 18, the black-bordered button 1704 for selecting memory card is selected. Also, it is possible to change output destinations according to the kind of the printing order instead of the order from a user. For example, when the printing order is from the reservation printing function of a receiving apparatus, it is possible to output printing only data to a memory card. The reason is as follows: in the case of printing only data being outputted via a communication terminal at the time of reservation printing, when the printer has a paper jam, a user cannot restart the printing operation because the user is not beside the printer. In this case, next printing order from the reservation printing function cannot be executed. Outputting to a memory card eliminates the fear. When a memory card is filled to memory capacity, it is possible to change the output destination to the communication terminal.

Also, the receiving apparatus shown in FIG. 7 in the first embodiment deletes the printed printing only data when storing printing only data in a memory card, other timing of deleting the printed printing only data can be selected. For example, it is possible to delete the printed printing only data when a memory card is inserted into a memory card reader/writer of the receiving apparatus or when a deletion instruction is received from a user via the printing instruction reception unit.

In addition, it is also possible to delete all the data stored in a memory card when the memory card is inserted into a receiving apparatus.

The printer in the second embodiment deletes the file name registered on the list of undeleted data from the list after a certain time period, but it is possible not to delete the data.

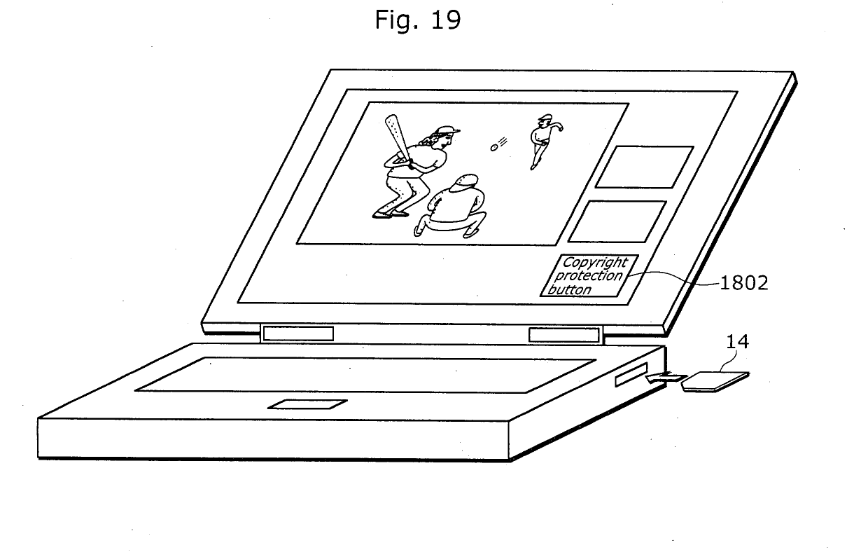

Also, in the second embodiment, if a user wants, the receiving apparatus can surely write printing only data in a memory card. However, some of printing only data should not be written in a memory card from the viewpoint of copyright protection. Therefore, for example, there is an idea of preparing copyright protection button 1802 in the authoring tool used when making printing only data as shown in FIG. 19. When clicking the copyright protection button 1802, the program of display script file 107a shown in FIG. 5 and FIG. 6 is automatically rewritten in order not to allow the in-process printing only data to be written in a memory card.

Further, a case where printing only data is superimposed on television signals is explained in the above-mentioned embodiment, but the embodiments of the invention may be varied in many ways. For example, printing only data can be distributed via a communication network such as the Internet. Also, the receiving apparatus that receives printing only data is not limited to the receiving apparatus that reproduces television signals, in other words, a personal computer or a PDA (Personal Digital Assistant) will do. Further, data to be printed or stored is not limited to printing only data, in other words, a hard copy of the display screen will do.

The present invention makes it possible to print printing data in a way suitable for respective receiving apparatuses without preparing printing data for respective kinds of receiving apparatuses.

Also, the data amount of broadcasting signals can be reduced.

The most suitable output destinations of printing data can be determined in both a receiving apparatus connectable to a printing apparatus and a receiving apparatus unconnectable to the printing apparatus.

As a user do not have to specify the output destination of printing data, it is possible to lighten the workload for the user.

If a user wants, the user can change the output destination of printing data.

The printing data printed in the printing apparatus can be deleted in the receiving apparatus.

A copyright of printing only data can be protected.

A user can surely delete the printed printing data even when it is impossible to write data in printing apparatus.

It is possible to store printing data in an external memory device one after another and then print the data all together.

It is possible to limit the printing times of printing data, which leads to protect a copyright.

It is also possible to output the printing data to the output destination specified by the user.

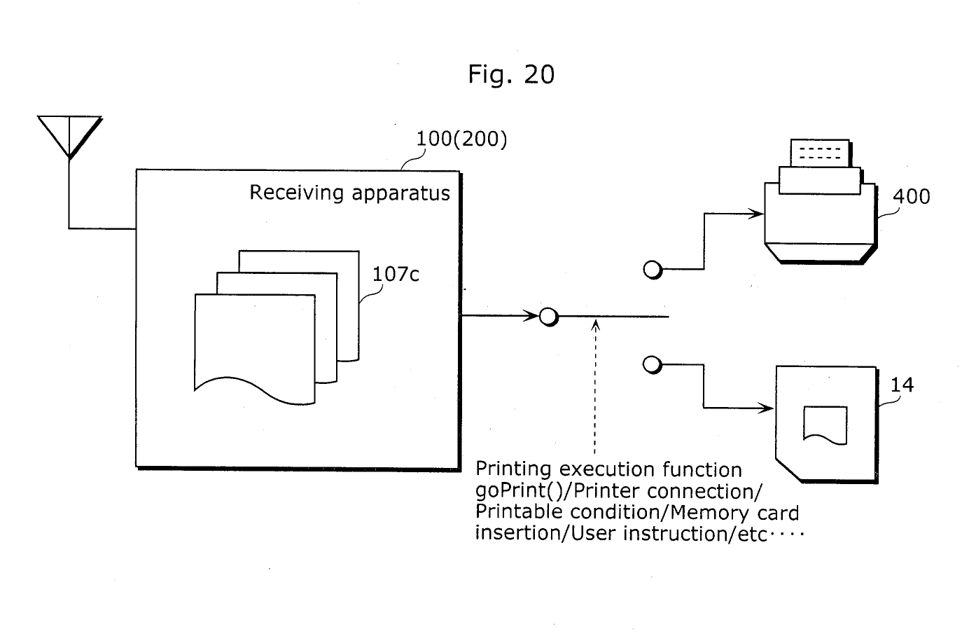

To sum up, as shown in FIG. 20, receiving apparatus 100 (200) outputs printing only data 107c printer 400 or memory card 14 based on the following conditions: presence or absence of printing execution function goPrint(), whether receiving apparatus 100 (200) is connected to printer 400 or not, whether printer 400 is ready for printing or not, whether memory card 14 is connected to receiving apparatus 100 (200) or not, whether there is an instruction for specifying the output destination of printing only data 107c from a user or not and so on.

As explained up to this point, the receiving apparatus for television broadcasting and the printing apparatus for printing printing data received by the receiving apparatus in the present invention can automatically select output destinations of printing data, and can automatically delete the printed printing data. Therefore, data management of the printing data becomes simpler, and thus this present invention has very high practical value especially as a receiving apparatus for digital television broadcasting that includes printing only contents and a printing apparatus for printing printing only data received by the receiving apparatus.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A receiving apparatus for receiving a signal containing printing data, comprising:
a printing data receiving unit operable to receive the printing data contained in the signal;
an output destination determination unit operable to selectively determine whether to output the printing data to a printing apparatus or not based on information on the printing apparatus for printing the printing data; and
a printing data output unit operable to output the printing data to the printing apparatus when the output destination determination unit determines to output the printing data to the printing apparatus.

2. The receiving apparatus according to claim 1 further comprising an external memory writing unit operable to send or receive data to or from a detachable external memory device and write the printing data in the external memory device;
wherein the output destination determination unit selects the printing apparatus or the external memory device as an output destination of the printing data based on the information on the printing apparatus, and
the printing data output unit outputs the printing data to the destination determined by the output destination determination unit.

3. The receiving apparatus according to claim 2,
wherein the printing data output unit stores information on a printing job of the printing data in the external memory device when an output destination determined by the output destination determination unit is the external memory device.

4. The receiving apparatus according to claim 2,
wherein the output destination determination unit selects the printing apparatus as an output destination of the printing data when a control program for printing the printing data using the printing apparatus exists in the receiving apparatus.

5. The receiving apparatus according to claim 2,
wherein the output destination determination unit determines an output destination of the printing data based on the condition of the printing apparatus.

6. The receiving apparatus according to claim 5,
wherein the output destination determination unit selects the printing apparatus as an output destination of the printing data when the printing apparatus is connected to a receiving apparatus.

7. The receiving apparatus according to claim 5,
wherein the output destination determination unit selects the printing apparatus as an output destination of the printing data when the condition of the printing apparatus is ready for printing.

8. The receiving apparatus according to claim 7,
wherein the output destination determination unit selects the printing apparatus as an output destination of the printing data when the printing apparatus is power-supplied.

9. The receiving apparatus according to claim 7,
wherein the output destination determination unit selects the printing apparatus as an output destination of the printing data when printing paper is set in the printing apparatus.

10. The receiving apparatus according to claim 7,
wherein the output destination determination unit selects the printing apparatus as an output destination of the printing data when coloring materials are set in the printing apparatus.

11. The receiving apparatus according to claim 7,
wherein the output destination determination unit selects the printing apparatus as an output destination of the printing data unless the printing apparatus is in a process of printing.

12. The receiving apparatus according to claim 2 further comprising an output destination specification unit operable to receive specification of an output destination of the printing data from a user;
wherein, when a user specifies the output destination of the printing data, the output destination determination unit selects an output destination specified by a user as an output destination of the printing data.

13. The receiving apparatus according to claim 2 further comprising a program reception unit operable to receive a program in which an output method of the printing data contained in the signals is written;
wherein the output destination determination unit determines an output destination of the printing data according to the program.

14. The receiving apparatus according to claim 1,
wherein the external memory writing unit deletes the printing data stored in the external memory device when the external memory device is inserted.

15. The receiving apparatus according to claim 1,
wherein a flag showing “printed” indicates that the printing apparatus finished printing is attached to the printing data stored in the external memory device, and
the external memory writing unit deletes the printing data to which the flag showing “printed” is attached out of the printing data stored in the external memory device.

16. The receiving apparatus according to claim 15,
wherein the external memory writing unit deletes the printing data to which the flag showing “printed” is attached when the external memory device is inserted.

17. The receiving apparatus according to claim 15 further comprising a deletion instruction reception unit operable to receive a deletion instruction of the printing data stored in the external memory device from a user,
wherein the external memory writing unit deletes the printing data to which the flag showing “printed” is attached when the deletion instruction is made.

18. The satellite unit according to claim 15,
wherein the external memory writing unit deletes the printing data to which the flag showing “printed” is attached when storing the printing data in the external memory device.

19. The receiving apparatus according to claim 1,
wherein the printing data received by the printing data receiving unit is printing only data which is used only for printing, and
the output destination determination unit determines an output destination of the printing only data.

20. The receiving apparatus for receiving signals containing printing data comprising:
a printing data receiving unit operable to receive printing data contained in the signals;
an external memory writing unit operable to send or receive the data to or from the detachable external memory device and write the printing data in the external memory device;
an output destination determination unit operable to select a printing apparatus or the external memory device as an output destination of the printing data based on information on the external memory device; and
a printing data output unit operable to output the printing data to an output destination determined by the output destination determination unit.

21. The receiving apparatus according to claim 20,
wherein the output destination determination unit selects the external memory device as an output destination of the printing data when the external memory device is set in the receiving apparatus.

22. A printing apparatus for printing data stored in a detachable external memory device,
wherein the external memory device has a write-protect indication unit operable to show whether data writing is permitted or not, and
the printing apparatus comprises:
a printing data reading unit operable to read the printing data stored in the external memory device;
a printing unit operable to print the read printing data;
an identifier information memory in which identifier information of the printing data is stored;
a printing data deletion unit operable to delete the printed printing data and the printing data identified by the identifier information stored in the identifier information memory from the external memory device; and
a storage unit operable to store the identifier information of the undeleted printing data in the identifier information memory when the printed printing data cannot be deleted from the external memory device.

23. The printing apparatus according to claim 22 further comprising a warning generation unit operable to generate a warning when the write-protect indication unit of the external memory device does not permit writing.

24. The printing apparatus according to claim 22 further comprising an identifier information deletion unit operable to delete identifier information of the printing data stored in the identifier information memory over a certain period.

25. A printing apparatus for printing data stored in a detachable external memory device,
wherein in the external memory device, printing data and an identifier indicating whether the printing data is printed or not are stored, and
the printing apparatus comprises:
a printing data reading unit operable to read the printing data and the identifier stored in the external memory device;
a printing unit operable to print the unprinted printing data with reference to the identifier; and
an identifier value change unit operable to change an identifier value of the printed printing data to a value showing that said printing data is printed.

26. The printing apparatus according to claim 25 further comprising:
a display unit operable to display the unprinted printing data to a user with reference to the identifiers;
a reception unit operable to receive the printing data for printing request of the unprinted printing data from a user; and
wherein the printing unit prints the printing data received by the printing unit.

27. A printing apparatus for printing data stored in a detachable external write-once memory device,
wherein in the external memory device, printing data and an identifier showing that the printing data is printed are stored, and
the printing apparatus comprises:
a printing data reading unit operable to read the printing data and the identifier stored in the external memory device;
a printing unit operable to print the printing data without the associated identifier; and
an identifier writing unit operable to write the identifier associated with the printed printing data in the external memory device.

28. A printing system for printing printing data contained in a signal, comprising:
a receiving apparatus for receiving the signal; and
a printing apparatus for printing the printing data received by the receiving apparatus,
wherein the receiving apparatus includes:
a printing data receiving unit operable to receive printing data contained in the signals;
an output destination determination unit operable to selectively determine whether to output the printing data to a printing apparatus or not based on information on the printing apparatus for printing the printing data; and
a printing data output unit operable to output the printing data to the printing apparatus when the output destination determination unit determines to output the printing data to the printing apparatus.

29. The printing system according to claim 28,
wherein the receiving apparatus further comprising an external memory writing unit operable to send or receive data to or from the detachable external memory device and write the printing data in the external memory device,
wherein the output destination determination unit selects the printing apparatus or the external memory device as an output destination of the printing data based on the information on the printing apparatus, and
the printing data output unit outputs the printing data to an output destination determined by the output destination determination unit.

30. The printing system according to claim 29,
wherein the output destination determination unit selects the printing apparatus as an output destination of the printing data when a control program for printing the printing data using the printing apparatus exists in the receiving apparatus.

31. A method for outputting printing data contained in a signal, comprising the steps of:
receiving the printing data contained in the signal;
selecting one of a printing apparatus and a detachable external memory device as an output destination of the printing data based on information on the printing apparatus for printing the printing data; and
outputting the printing data to the selected output destination.

32. The output method for printing data according to claim 31,
wherein in the selection step, the printing apparatus is selected as an output destination of the printing data when a control program for printing the printing data using the printing apparatus exists in the receiving apparatus, or the external memory device is selected as an output destination of the printing data when the control program does not exist.

33. A method for printing printing data stored in a detachable external memory device in a printing apparatus,
wherein the external memory device comprises a write-protect indication unit operable to show whether data writing is permitted or not, and
the printing apparatus comprises an identifier information memory in which identifier information of the printing data is stored, and
the picture printing method comprises the steps of:
reading the printing data stored in the external memory device,
printing the read printing data;
judging whether data can be written in the external memory device is permitted or not;
deleting the printed printing only data and the printing data specified by the identifier information stored in the identifier information memory from the external memory device when the write-protect indication unit permits data writing; and
storing the identifier information of the printed printing data in the identifier information memory when the write-protect indication unit does not permit data writing.

34. The picture printing method according to claim 33 further comprising a step for issuing a warning when the write-protect indication unit does not permit data writing.

35. A method for printing printing data stored in a detachable external memory device,
wherein in the external memory device, printing data and an identifier showing whether the printing data is printed or not is stored,
the picture printing methods comprises the steps of:
reading the printing data and the identifiers stored in the external memory device;
displaying the unprinted printing data to a user with reference to the identifier;
receiving the printing data which requires to be printed out of the unprinted printing data from a user;
printing the unprinted printing data received from the user with reference to the identifiers; and
changing a value of the identifier associated with printed printing data.

36. A picture printing method for printing printing data stored in a detachable external write-once memory device,
wherein in the external memory device, printing data and an identifier showing that the printing data is printed is stored, and
the picture printing methods comprises the steps of:
reading the printing data and the identifiers stored in the external memory device;
printing data without the associated identifiers; and
writing the identifiers associated with the printed printing data in the external memory device.
